(19) United States
(12) Patent Application Publication
(10) Pub. No.: US 2006/0050621 A1
(43) Pub. Date: Mar. 9, 2006

(54) Optical scanning device

(76) Inventors: Coen Theodorus Hubertus Fransiscus Liedenbaum, Eindhoven (NL); Teunis Willem Tukker, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/531,030

(22) PCT Filed: Sep. 12, 2003
(86) PCT No.: PCT/IB03/04049

§ 371 Date: Apr. 12, 2005

(30) Foreign Application Priority Data
Oct. 15, 2002 (EP) 02079298.2

(51) Int. Cl. G11B 7/00

(52) U.S. Cl. 369/125

(57) ABSTRACT

An optical scanning device 1 detects an information signal from an optical record carrier 2 using differential interference contrast. Two radiation beams 13a, 13b are generated and focused to two distinct spots 15a, 15b respectively displaced along a data track on the information layer of an optical record carrier. The relative positions of the spots in lands and pits can generate a path length difference between the reflected beams 17a, 17b. This path length difference causes the beams to interfere either constructively or destructively, depending on the relative land/pit position in the data track of the spots. This interference causes a detectable signal to be generated, the signal being representative of a transition from a pit to a land on the information layer 4 or vice versa.

This invention relates to an optical scanning device for scanning optical record carriers.

In known optical scanning devices, for example compact disc (CD) and digital versatile disc (DVD) recorders and players, data stored on an optical record carrier is extracted by converting incident radiation, reflected off the record carrier to an electronic data signal. Using appropriate manipulation by suitable electronics, the data can be retrieved with a suitable signal to noise ratio.

In such detection systems, the high frequency electronic data signal is first converted using an analogue to digital (A to D) converter and, after the zero crossing, is detected at a selected point, where jitter is lowest. Variations in reflectivity, noise induced in the system by the electronics, the record carrier or the radiation source will degrade the signal to noise ratio and increase the bit error rate. Presently, 6 bit A to D converters are used, having 64 quantization levels, but systems have been proposed requiring higher bandwidth converters. In high speed systems the lock frequency of the A to D conversion is relatively high, causing higher power consumption and electromagnetic compatibility problems.

According to the invention there is provided an optical scanning device for scanning an information layer of an optical record carrier, the information layer including a data track arranged as a series of pits and lands with transitions between the pits and lands, the device including a radiation source for generating radiation and an optical arrangement for transmitting the radiation towards the optical record carrier, and after scanning of the optical record carrier, towards a detection system, the optical arrangement generating two radiation beams respectively forming two scanning spots displaced with respect to one another on the information layer, characterized in that the optical arrangement is adapted to align the spots with respect to one another along the direction of the data track, and in that the detection system is arranged to detect variations in the reflected beams as a result of interference caused by differences in path lengths of the two radiation beams, which differences indicate a transition between a pit and a land in the data track.

The device detects an information signal using differential interference contrast in the optical domain. In this way, it is possible to reduce the complexity of A to D conversion in the electronic signal processing part of the optical scanning device.

Further objects, advantages and features of the invention will be apparent from the following more particular description, given by way of example, of preferred embodiments of the invention, as illustrated in the accompanying drawings, in which:

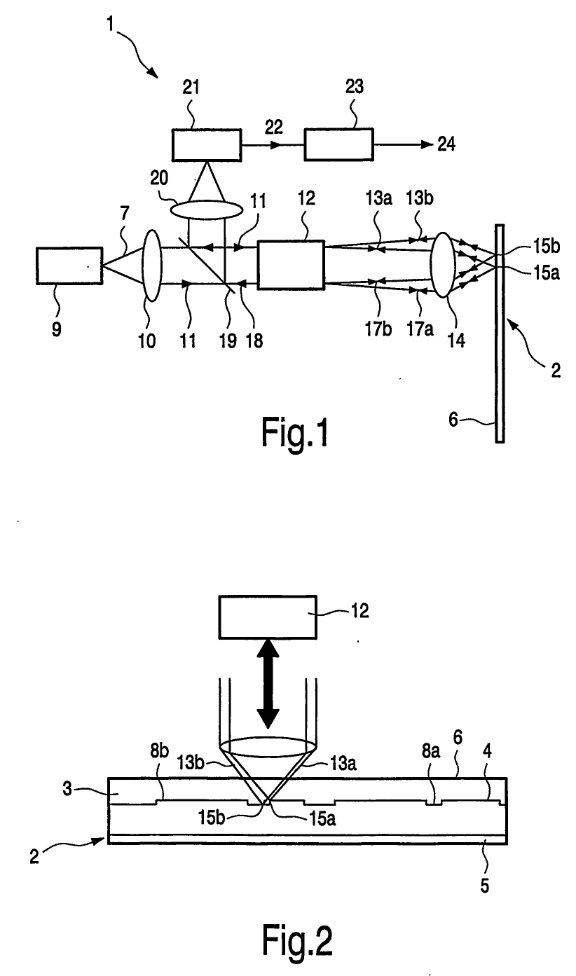

FIG. 1 is a schematic drawing of an optical scanning device incorporating an optical pick up unit in accordance with an embodiment of the invention, focusing two radiation beams on a record carrier;

FIG. 2 is a schematic drawing of the pick up unit of FIG. 1, showing two secondary radiation beams incident on a pit and a land on an optical record carrier;

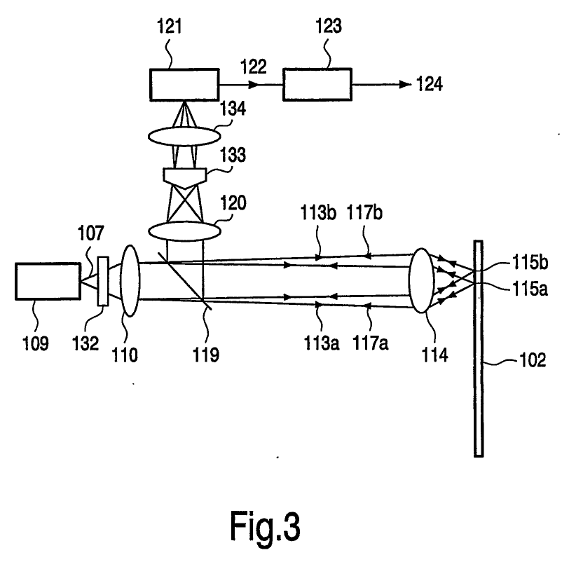

FIG. 3 is a schematic drawing of an alternative form of optical scanning device in accordance with a further embodiment of the invention;

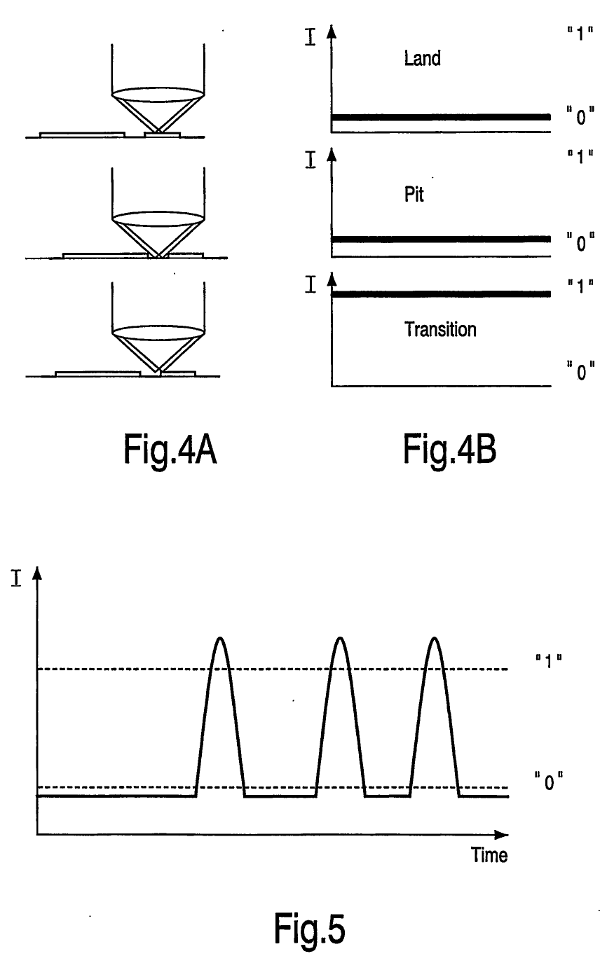

FIG. 4A is a schematic drawing showing some of the various data track positions of the two incident radiation beams on an optical record carrier;

FIG. 4B shows the respective detector signal output levels corresponding to the focusing positions shown in FIG. 4A; and

FIG. 5 shows an exemplary information signal response when an optical record carrier is scanned by an optical pick up unit in accordance with the invention.

FIG. 1 shows elements of an optical scanning device 1, including an optical head scanning an optical record carrier 2. The record carrier 2, shown in more detail in FIG. 2, is in the form of an optical disk comprising a transparent layer 3, on one side of which an information layer is arranged. The information layer 4 may include a reflective metallic coating. The side of the information layer 4 facing away from the transparent layer 3 is protected from environmental influences by a protection layer 5. The side of the transparent layer 3 facing the device is called the entrance face 6. The transparent layer 3 acts as a substrate for the record carrier by providing mechanical support for the information layer. Alternatively, the transparent layer 3 may have the sole function of protecting the information layer, while the mechanical support is provided by a layer on the other side of the information layer, for instance by the protection layer 5 or by a further information layer and a transparent layer connected to the information layer 4. Information may be stored in the information layer 4 of the record carrier in the form of optically detectable marks arranged in substantially parallel, concentric or spiral tracks, not indicated in FIG. 1 or 2. The marks may be in the form of pits and alternately interspersed between lands 8a, 8b respectively.

The scanning device 1 comprises a radiation source in the form of a semiconductor laser 9 emitting a radiation beam 7. The radiation beam 7 is used for scanning the information layer 4 of the optical record carrier 2. The radiation 7 is incident on a collimator lens 10, which converts the radiation beam 7 into a collimated beam 11. The collimated beam 11 is incident on an optical element 12, which produces two secondary coherent radiation beams 13a, 13b from the single primary beam 11. The beams 13a, 13b from the optical element 12 are incident on an objective lens system 14. The objective lens system 14 may comprise one or more lenses and/or a grating. The objective system 14 in FIG. 1 consists of a single lens 14 that focuses beams 13a, 13b to two distinct spots 15a, 15b on the record carrier 2. The two spots 15a, 15b are displaced from one another in the direction of scanning of the optical record carrier 2.

Radiation reflected by the information layer 4 forms two diverging beams, transformed into substantially collimated beams 17a, 17b by the objective system 14. The substantially collimated beams 17a, 17b are incident on the optical element 12 and combined therein to form a single beam 18 incident on a beam splitter 19. The beam splitter 19 separates the forward and reflected beams by transmitting at least part of the reflected beam 18 towards a collimator lens 20 focusing radiation onto a detection system 21 including a photodetector array. The detection system 21 captures the radiation and converts it into electrical output signals which are processed by signal processing circuits 23 which are located in the scanning device separately from the optical head 1.

One of the electrical output signals is an information signal 22, the value of which represents information read from the information layer 4. The information signal 22 is converted to a processed information signal 24 by signal processing circuits 23, and then processed by an information processing unit for error correction and passed to an output device.

Other signals (not shown) from the detection system include a focus error signal and radial error signal. These may be generated by detection in the system 21 of three beams which are generated in the device separate from the beams from which the information signal is detected. The focus error signal represents the axial difference in height between the spots 15a, 15b and the information layer 4, for example when scanning a land. The radial error signal represents the distance in the plane of the information layer 4 between the spots 15a, 15b and the center of a data track in the information layer being scanned by the spots.

The focus error signal and the radial error signal are fed into a servo circuit (not shown), which converts these signals to a focus correction signal and a tracking correction signal for controlling high bandwidth mechanical actuators (not shown) in the optical head. The mechanical focus actuator controls the position of the objective system 14 in the focus direction, thereby controlling the axial position of the spots 15a, 15b such that they coincide substantially with the plane of the information layer 4, and the radial position of the spots 15a, 15b, such that they accurately follow the center of a track in the information layer currently being scanned. A further mechanical actuator, such as a radially movable arm, alters the position of the optical head 1 in a radial direction of the record carrier 2, thereby coarsely controlling the radial position of the spots 15a, 15b to lie above a track to be followed in the information layer 4. The tracks in the record carrier 2 run in a direction perpendicular to the plane of FIG. 1.

FIG. 2 illustrates the concept of the invention in more detail. As can be seen in FIG. 2, the optical element 12 is arranged to generate two radiation beams 13a, 13b which concurrently form spots 15a, 15b on the information layer 4 of the record carrier 2.

The two separate radiation beams 13a, 13b are generated by one of several methods to be described below. However, it should be noted that any suitable method or apparatus capable of forming two radiation beams from a single radiation source may be used.

As mentioned above, two spots 15a, 15b are formed on the information layer 4 of the record carrier 2. The spots 15a, 15b are displaced tangentially from each other along the data track in the information layer 4. The optical element 12 is arranged such that the two spots 15a, 15b are positioned along a line parallel to the track tangential direction, so that both spots 15a, 15b scan the track in the same transverse position in the track. As the two radiation beams are generated from a single radiation beam, the reflected beams upon their return to the optical system will interfere constructively or destructively. The nature of the interference will depend on the optical paths used to provide the relative positioning of the spots 15a, 15b on the information layer 4. For example when both spots 15a, 15b are focused on a land or a pit, there will not be a path difference and the interference will be constructive. Accordingly, there will be a substantial amount of radiation reflected back through the optical pick up unit and on to the detection system 21.

However, if one spot 15a is on a pit and the other spot 15b is incident on a land, and with appropriate selection of the difference in height between the lands and pits, there will be a path difference between the two beams such that the interference will be destructive, leading to substantially no radiation reflected back through the optical pick up unit and on to the detector system 21.

In this way transitions from land to pit, and vice versa, are detected in the information layer 4 of the record carrier.

The optical element 12 used to generate two secondary radiation beams from a single radiation source may be a Wollaston prism. Wollaston prisms are usually formed from birefringent materials, i.e. materials having different optical properties in orthogonal directions. When a radiation beam is incident on a birefringent material, two beams can be generated that have orthogonal polarizations and are respectively displaced from one another. When a Wollaston prism is used as optical element 12, a linearly polarized radiation source 9 with a polarization direction arranged at 45° to the optic axis of the prism 12 is used. Also, a polarizing analyzer plate, not shown, is placed between the detector system 21 and the beam splitter 19 with its optic axis at 45° to the equivalent direction of polarization.

In a further embodiment of the invention, shown in FIG. 3, the optical element comprises a diffraction grating generating two secondary beams having a predetermined phase relationship. A two spots grating having a phase difference of π can be generated with a binary grating with one groove per unit distance (d). The design parameters and performance of one example of such a grating, using two step heights introducing a relative phase delay of π and lands and grooves of equal width (0.5d), are given in the table below. However, it will be appreciated that other gratings having suitable characteristics may be used.

TABLE

| Order | Intensity | phase |
|---|---|---|
| −1 | 40.53% | −π/2 |
| 0 | 00.00% | — |
| +1 | 40.53% | π/2 |

In this embodiment, the elements having similar functions in common with the first embodiment of FIGS. 1 and 2 retain the same reference numerals, incremented by a value of 100. As can be seen in FIG. 3, a single radiation beam 107 generated by a source 109 is incident on an optical element 132, comprising a binary diffraction grating and a collimator lens 110. The optical element 132 generates two secondary radiation beams 113a, 113b which are focused in the manner described above on the information layer on the optical record carrier 102. The optical element 132 is arranged such that the two spots 115a, 115b are positioned along a line parallel to the track tangential direction, so that both spots 115a, 115b scan the track in the same transverse position in the track. The radiation reflected from the information layer is transmitted back to the beam splitter 119. The beam splitter 119 separates the forward and reflected beams by transmitting at least part of the reflected beams 117a, 117b towards a detection system 121. It should be noted that the reflected beams are transmitted to the detection system without passing again through the optical element 132 and are recombined after reflection by beam splitter 19. After refraction by collimating lens 20, the beams are incident on a wedge element 133 and a combining lens 134. These components allow the secondary radiation beams to overlap at the detector system 21.

As a phase difference of π is added by the optical element 132, the radiation beams will interfere destructively if both spots 115a, 115b are on a land or a pit and will interfere constructively if one spot 115a is on a land and the other spot 115b is on a pit or vice versa.

In the above embodiments, the signal processing system 23; 123 may include an amplifier where amplification saturates the output stage. The output of the amplifier can be fed into a digital decision circuit in signal processing circuitry 23; 123, such as a flip-flop, from which subsequent data extraction can occur. The amplification stage is arranged such that the zero level is not amplified to such an extent that it rises above the threshold level for the decision circuit. To reduce the zero level, an electronic high pass filter may be inserted before the amplifier.

Referring to FIGS. 4A, 4B and 5, an exemplary response of the detector system can be seen. FIG. 4B shows the detected information signal 22; 122 in various states corresponding to the detection of a land, pit and transition, as shown schematically in FIG. 4A. When both spots are on a land or a pit, the radiation incident on the detector system will be approximately zero, as the radiation beams will destructively interfere. When the spots are either side of a transition, the radiation beams will constructively interfere and a higher signal will be incident on the detector system. Whilst in this example, a low signal level is seen in land and pits and a high level is seen at transitions, due to the introduction of a phase difference of π between the secondary beams in the optical arrangement, the opposite will be seen where no phase difference is introduced in the optical arrangement.

FIG. 5 shows the detected information signal showing peaks at detection transitions between a pit and a land, and vice versa, as the optical pick up unit is scanned across a track of the information layer of a record carrier. The peaks in the signal are generated at the transitions when the radiation is scanned from pit to land, or vice versa, in the information layer. The width of the peaks is determined by the scan speed, the displacement between the spots and the quality of the interference.

In order to obtain optimum signal to noise ratio, the destructive interference level should be as close to zero as possible. In order to obtain optimum contrast, the depth of the pits is preferably set at 0.25 wavelength optical depth. In order to avoid significant levels of self-interference in one of the secondary beams, the track pitch p, radiation wavelength λ and numerical aperture NA of the objective preferably accord with the following relation:

$$P < \frac{λ}{2 NA} .$$

The invention described above requires no complex A to D converters in the signal processing circuitry 23; 123. This is advantageous for the reasons described above. However, there are further advantages. For example, scaling up to higher bandwidth is straightforward and merely requires a higher bandwidth photodetector and a decision circuit that runs at the data-speed. In conventional optical scanning devices the A to D converters run at much higher speeds in order to achieve sufficient resolution.

Furthermore, suppression of electronic noise sources can be achieved as the intricate handling of difference signals of the various detector segments is avoided. Additionally, it is more easily possible to introduce limit equalization to preferentially increase the signal of the shortest data segments, since a return to zero signal is provided instead of a non return to zero signal.

It will be appreciated that all of the components specifically described above may be replaced by suitable alternatives performing substantially the same function.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical scanning device for scanning an information layer of an optical record carrier, the information layer including a data track arranged as a series of pits and lands with transitions between the pits and lands, the device including a radiation source for generating radiation and an optical arrangement for transmitting the radiation towards the optical record carrier, and after scanning of the optical record carrier, towards a detection system, the optical arrangement generating two radiation beams respectively forming two scanning spots displaced with respect to one another on the information layer, characterized in that the optical arrangement is adapted to align the spots with respect to one another along the direction of the data track, and in that the detection system is arranged to detect variations in the reflected beams as a result of interference caused by differences in path lengths of the two radiation beams, which differences indicate a transition between a pit and a land in the data track.

2. An optical scanning device according to claim 1, in which the optical arrangement includes an optical element, wherein the radiation source forms a single radiation beam which is split into two secondary radiation beams by the optical element.

3. An optical scanning device according to claim 2, in which the optical element comprises a diffraction grating.

4. An optical scanning device according to claim 3, in which the diffraction grating introduces a phase difference between the two secondary radiation beams.

5. An optical scanning device according to claim 4, in which the diffraction grating generates a phase difference of n between the two secondary radiation beams.

6. An optical scanning device according to claim 2, in which the optical arrangement is such that the two secondary radiation beams are transmitted from the information layer to the detection system without being incident on the optical element.

7. An optical scanning device according to claim 2, in which the optical element comprises a birefringent material.

8. An optical scanning device according to claim 7, in which the optical element comprises a Wollaston prism.

9. An optical scanning device according to claim 1, in which the detection system is adapted to generate an electrical signal, said electrical signal comprising a series of peaks.

10. An optical scanning device according to claim 9, wherein each said peak is representative of a transition between a land and a pit in the data track.

11. An optical scanning device according to claim 1, the detection system includes a photodetector, said two beams being combined prior to the position of the photodetector.
